(19) United States
(12) Patent Application Publication
(10) Pub. No.: US 2009/0320538 A1
(43) Pub. Date: Dec. 31, 2009

(54) METHOD FOR CONTROLLING THE LOCKING OF A LOCK, AND LOCK

(75) Inventor: Pierre Pellaton, Le Locle (CH)

Correspondence Address: PEARNE & GORDON LLP, 1801 EAST 9TH STREET, SUITE 1200, CLEVELAND, OH, 44114-3108, US

(73) Assignee: KABA AG, Wetzikon (CH)

(21) Appl. No.: 12/104,967

(22) Filed: Apr. 17, 2008

Related U.S. Application Data
(63) Continuation of application No. PCT/EP2006/067589, filed on Oct. 19, 2006.

(30) Foreign Application Priority Data
Oct. 24, 2005 (EP) 05109900

(51) Int. Cl. E05B 49/00; G08B 29/00

(52) U.S. Cl. 70/278.1; 340/5.51; 340/5.52

(57) ABSTRACT

Method for controlling the locking of an electronic lock (5), including the following steps:
a user (4) is identified vis-à-vis the electronic lock,
the electronic lock (5) displays a question,
the user transmits the question to a central station (1),
the central station computes the answer to the question and transmits this answer to the user,
the user enters the answer in the lock,
the lock verifies whether the response is correct and decides according to this answer whether to unlock the door
a receipt code is displayed by the lock (5) and transmitted by the user to the central station (1) with the aid of the mobile equipment (3).

### REFERENCE DATA

This application is a continuation of international patent application PCT/EP2006/067589, filed on Oct. 19, 2006, claiming priority from European patent application EP05109900, filed on Oct. 24, 2005, both incorporated herewith by reference.

### TECHNICAL FIELD

The present invention relates to a method for controlling the locking of an electronic lock. The present invention also relates to an electronic lock suitable for implementing this process. The present invention relates in particular to a lock offering the level of security required for money distributors (ATM, Automatic Teller Machines) or safes.

### RELATED ART

Conventional locks are locked or unlocked by means of mechanical or electronic keys. The distribution of the keys is restricted to users authorized to access the contents protected by the lock. The level of protection depends on the ease with which the keys can be falsified and on the trust put in the bearers of the key.

In the case of automatic teller machines, access by the front side is secured by means of a card reader and of a keypad allowing different users to identify themselves before getting a limited number of bank notes. Access to the distributor's rear side is however generally closed by means of a conventional key lock. Bank employees, cash replenishers, technical service reps and repair personnel all share copies of the same key that allow access to the safes frequently holding tens of thousands of Euros in cash or in a container. There is a considerable risk for one of these keys to get lost or stolen and to fall in the wrong hands. Furthermore, it is extremely difficult to find the culprit in the case of theft by an unscrupulous employee when a key is distributed to many users.

In order to remedy these problems, the company Kaba Mas (registered trademark) has offered for several years a lock sold under the name Cencon System 2000 (registered trademark). This lock can be opened by means of a conventional electronic key allowing its bearer to be identified, and of a one-way secret code OTC (One Time Combination, registered trademark). The OTC code is communicated to the user from a central station, for example through a phone call. Only a user capable of presenting at the same time an electronic key and a valid OTC code is authorized to access the contents of the protected teller machine.

This solution however has the disadvantage of always requiring physical keys associated with each teller machine. A route personnel requires as many keys as teller machines that are to be supplied during his round, or else a key programmed to open several teller machines in combination with different OTC codes. Administering and programming the keys to be distributed to the different users is a headache from an administrative point of view, especially when a key is lost.

Furthermore, a user having fraudulently acquired a key could be tempted to call the central station by usurping the identity of the key's authorized bearer in order to obtain a valid OTC code. The security afforded is thus insufficient.

Furthermore, the reader of the electronic key comprises electric, electronic and/or electro-mechanic elements that give additional possibilities for manipulation and fraud.

Patent application EP0546701 describes a method for controlling the locking of strongboxes wherein the security is ensured by means of different PIN codes and encoded messages that the user must enter in a terminal belonging to him. This terminal is then connected with the protected strongbox in order to cause it to unlock. This terminal, which usually is in the hands of the user, constitutes a target for hackers tempted to analyze it or to make a compatible terminal in order to access non-authorized strongboxes.

EP0935041 describes a device and method for opening locks, relying on use of an electronic case used notably for identifying the operator and inserted into the lock. The case comprises a display for displaying a question computed in cooperation by the lock and by the case. This question is transmitted to the operator by telephone to a central station that computes the response entered manually into the case. The lock is opened in case of a correct answer. A receipt is displayed, which is transmitted to the central station according to the same mode.

In this solution, the computing of the question, its display, the entering of the answer and its verification are always performed at least partly by a device belonging to the user, which could be manipulated by a malicious user. The distribution of such devices to the users is complicated from an administrative point of view; it is necessary to ensure that the users, for example cash couriers, who cease their activity or who are responsible of a different stock of locks, replace their device.

Furthermore, no verification is made as to the plausibility of the question.

WO01/59725 describes a method for identifying a user by means of a portable telephone, for example for settling transactions as the point of sale. The method uses a code computed in the user's portable telephone and a similar code computed from the same parameters. This document does not concerning the unlocking of a lock. The security of the method rests again partly on a code computed in a device, here a telephone, held by the user and that can thus be manipulated.

U.S. Pat. No. 5,259,029 describes a challenge and response mechanism for authenticating the user of a computer program. The challenge is displayed on the computer, the user enters it in a personal apparatus which supplies the response the user must enter on the keyboard. This document does not pertain to locks of safes and does not rely on a central station to control the unlocking of several locks.

US2003/231103 describes a method for identifying a lock user by means of a chip card. The user must then supply a code which he can for example obtain from a central server by telephone. Again, the security relies on an object that can be falsified in the hands of a user.

One aim of the present invention is thus to provide a method for controlling the unlocking of a lock, wherein security cannot be compromised by manipulating devices or keys distributed to the users.

Generally, one aim of the present invention is thus to propose a method and a lock that allow the disadvantages of the prior art methods and locks to be avoided.

According to the invention, these aims are notably achieved by means of a method for controlling the locking of an electronic lock, including the following steps:

a user is identified vis-à-vis the electronic lock,

the electronic lock displays a question, preferably a single-use question,

the user transmits the question to a central station,

the central station computes the answer to the question and transmits this answer to the user,

the user enters the answer in the lock,

the lock verifies whether the response is correct and decides according to this answer whether to unlock the door.

This method notably has the advantage of forcing the user to transmit a question asked by the lock of the teller machine to the central station. This additional operation allows extra tests to be performed, for example to check in the central station whether the asked question is indeed valid.

This method also has the advantage of basing the identification of the user no longer necessarily on a physical key but for example by means of a password, PIN or biometric data that are more difficult to steal. Security thus does not rely on an object that the user carries along but only on the lock, which is difficult to access, and on a remote central station. The user needs a device, for example a mobile telephone, but only in order to connect with the central station. In one embodiment, additional plausibility tests are performed with this mobile telephone, for example to verify whether the SIM card belongs to an authorized user. However, even a falsified telephone and card are not sufficient to open the lock.

In the case of the user being identified by means of a password or a PIN, this method has the advantage of allowing passwords to be distributed, replaced or invalidated very easily, at a distance, by simple software operations from a central station.

In a variant embodiment, the secret code used for identifying the user is verified by the central station 1 and not by the lock. It is thus possible to avoid lists of authorized users to be transmitted to the different locks.

This method also has the advantage that all the data and codes necessary for unlocking the lock can be entered directly in the lock, without traveling through an intermediary equipment presenting additional vulnerability to attacks.

The present invention also concerns an electronic lock including:

data entering means for entering a personal identification code and means for verifying said personal identification code,

a module for generating and then displaying a question in response to an accepted personal identification code being entered,

a module for verifying whether an answer to said question entered on said keypad is correct and for causing said lock to be unlocked in case of a correct answer.

This lock is adapted for the aforementioned method; it further has the advantage of not imperatively requiring a key reader, which is vulnerable and costly.

The present invention also concerns a method for a central station for administering a pool of electronic locks, including the steps of:

distributing personal codes to a plurality of users in order to allow them to be identified vis-à-vis at least certain of said locks,

determining the access rights of each user to each lock,

receiving a question transmitted by one of said users through a telecommunication network,

verifying the plausibility of said question,

computing an answer to said question by means of a confidential algorithm,

transmitting said answer to said user.

This method can be implemented in an entirely automatic manner by a computer programmed for these different tasks, or with the assistance of a human operator or group of human operators using a computer.

### BRIEF DESCRIPTION OF THE DRAWINGS

Examples of embodiments of the invention are indicated in the description illustrated by the attached figures in which:

FIG. 1 illustrates in the form of a block diagram a system implementing the method and lock of the invention.

FIG. 2 illustrates in the form of a flux diagram the information exchange during the method of the invention.

### EXAMPLES OF EMBODIMENTS OF THE INVENTION

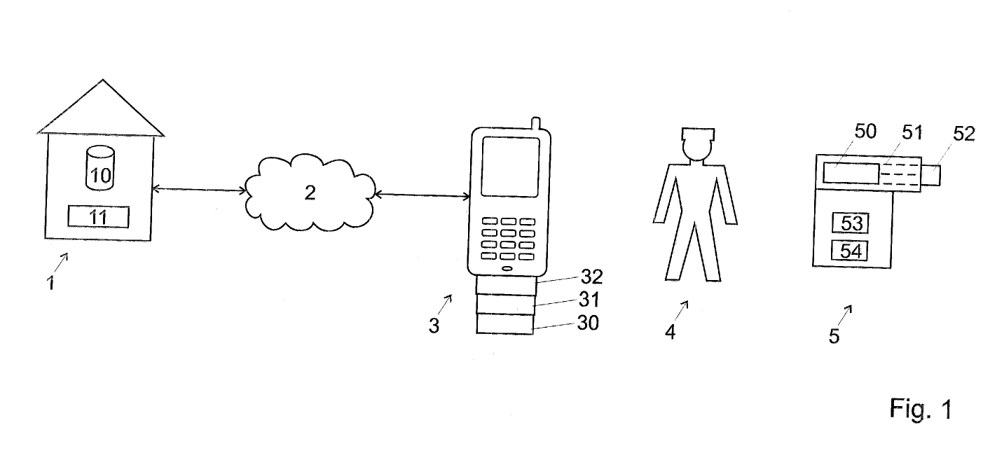

FIG. 1 illustrates in the form of a block diagram a system including a central station 1 to which different users 4 can connect with the aid of a mobile equipment 3 through a network 2. The system further includes one or several locks 5 to protect devices, not represented, for example teller machines, strongboxes, rooms or other volumes that are protected.

The central station 1 can be constituted for example by a call station, animated by several human operators, or a server or group of servers executing a specific application. The central station is typically responsible for the decision to unlock a whole stock of locks. The network 2 is for example a telecommunication network, for example a conventional telephone network, an Internet or Intranet type network, or preferably a mobile cellular network. The users can connect with the central station 1 by establishing a voice or data communication through the network 2.

In a preferred embodiment, the users connect with the central station 1 through a mobile cellular network 2 and by sending data, for example SMS (Short Message System), e-mails or IP data packets through a network 2 of the type GSM, GPRS, HSCSD, EDGE or GPRS for example. The central station preferably receives data automatically by means of a modem or a router suited therefore and can also answer to the user by sending its own data through the same channel or through a different channel. The data exchanged in one of the directions or in both directions can be signed electronically and/or encrypted by the central station 1 and/or by the mobile equipment 3, for example by using a chip card in the mobile equipment 3.

In another variant embodiment, the users 4 connect to the central station 1 by means of a voice communication. The central station 1 in this case employs human operators to react to this voice call and/or an IVR (Interactive Voice Response) voice recognition system to analyze the contents of the requests and/or of the user's DTMF codes and to synthesize a voice response.

The central station 1 further includes a database 10 of authorized users that contains for each user at least one personal code—or data for verifying a personal code—as well as authorizations, for example a list of locks the user is authorized to open. The registration corresponding to each user can further indicate temporal windows during which access to one or several locks is authorized, a user profile including for example the name, particulars, cryptographic communication keys with each user, a use history of the system (number of successful attempts, unsuccessful attempts, dates, times etc.) and other identification or authentication data, including for example a MSISDN caller number corresponding to the mobile equipment 3, biometric data etc.

Computing means 11 in the central station 1 allow an application program to be executed to administer the different users and their rights in the database 10. The computing means further allow an algorithm to be executed that makes it possible to compute the answer to a question (“challenge”) received from a user. This algorithm can for example consult a ROM correspondence table indicating the answer to each expected question or preferably compute a mathematical function from each question. The executed function is preferably chosen so that the knowledge of any number of answers to previous questions does not allow the answer to the next question to be predicted (pseudo-random function). The chosen algorithm, or values allowing it to be parametered (for example the seed in the case of a pseudo-random function) are preferably kept confidential. Furthermore, a different algorithm or different values are preferably used for each lock 5 and/or even for each user 4.

The central station 1 can further comprise a lock database (not represented) having for each lock 5 a profile with information such as geographic location, type of protected device, cryptographic communication keys etc.

The mobile equipment 3 depends on the type of network used. In a preferred embodiment, this equipment is constituted by a mobile cellular equipment, for example a cell phone or PDA, a smartphone or a personal computer provided with a cellular network connection card, a modem or a router. It is also possible to use a communication device dedicated to this use.

The mobile equipment 3 can include geolocation means 30, for example a satellite receiver of the type GPS, allowing its position to be determined and possible transmitted to the central station 1. A lone worker protection equipment (LWP) 31 makes it possible to check whether the user 4 of the mobile equipment 3 is awake, for example by checking whether he moves, is vertical, reacts to answer requests etc. The mobile equipment 3 can further include additional identification and/or authentication means 32, for example a chip card (e.g. SIM card), means for entering and verifying a PIN code, a biometric sensor, etc. The identification and/or authentication of the user 4 can be performed locally, i.e. in the mobile equipment or in a chip card inserted in the equipment, or remotely, i.e. for example in the central station 1 that then has means for verifying the data of the chip card, PIN codes and/or recorded biometric data. The mobile equipment 3 can for example be portable or installed in a vehicle.

It is however possible to use a conventional mobile telephone as mobile equipment within the frame of the invention; it is only necessary for the user to connect with this equipment with a central station 1 to send a question and receive a corresponding answer. It is even advantageous, in order to increase security, to establish communications between the different users and the central station through channels of different types. The central station can for example send this additional information and agree with a route personnel, for example, that the question is to be transmitted orally, even if the route personnel has an equipment allowing data communication.

The user 4 is for example a bank employee, a cash replenisher, a technical repair personnel or any other physical person authorized by the central station 1 to open the lock 5. The user 4 has knowledge of a secret personal code that has been transmitted by the central station 1 and with which he can be identified vis-à-vis one or several locks 5 of a pool of locks administered by the central station 1. The user 4 is furthermore preferably capable of being identified vis-à-vis his mobile equipment 3 by means of another secret code, for example a PIN code of the telephone and/or of the SIM card. Other means for identifying the user 4 vis-à-vis the lock 5 and/or the mobile equipment 3 can be conceived in the frame of the invention; for example, the user could prove his identity by presenting a personal object such as a key or chip card or by biometric identification by means of fingerprints, the iris, the retina, voice, the face etc. Other methods can obviously be used for identifying or authenticating the user 4 vis-à-vis the mobile equipment 3 and the lock 5. It is furthermore possible to cumulate several identification methods. Moreover, the identification data entered in the mobile equipment 3 can be transmitted to the central station 1 for verification purposes.

The lock 5 comprises an electro-mechanical element 52, for example a bolt, whose position is controlled by a logical device inside the lock 5 to act on a mechanical mechanism (“connecting rod”) allowing access to the protected volume, for example inside a teller machine, to be locked or on the contrary unlocked. The lock is preferably designed to be used in combination with a device containing the volume to be protected, for example with a teller machine or a strongbox; it thus does not itself constitute such a strongbox and does not have a protected volume but has means (not represented) to associate it mechanically and/or electrically with such a strongbox or teller machine in a manner making it difficult to be removed.

A numeric or alphanumeric keypad 51 associated with the lock 5 allows the user to enter his personal code and the answer to the asked questions. Other data entering elements (not represented), for example a biometric sensor, a camera, a microphone etc. can possibly be provided in the lock 5. The lock further includes a screen 50 for displaying messages in text or matrix mode, including questions, invitations to enter an answer, and status messages.

The lock further preferably comprises one or several optional interfaces 53 that allow it to exchange data with the device it has to protect, for example a teller machine, and/or with the central station 1 through any adapted network, for example a telephone network or Internet. Data communication with the device to be protected in which the lock is mounted makes it notably possible to increase security, thanks to the exchange of information allowing probable frauds to be detected by means of clue combinations and thanks to the generation of internal audit trail logs taking into account data collected both by the lock and by the protected device. This communication can also, if necessary, be used to control the lock 5 by means of the teller machine's keyboard, to display messages depending on the behavior of the lock 5 on the teller machine's screen, to forward alarms triggered by the lock by means of the teller machine or to trigger other actions performed by the teller machine. The preferably two-directional communication between the lock 5 and the central station 1 makes it possible for example to remotely modify the list of users authorized to be identified vis-à-vis each lock 5 (unless this verification is carried out by the central station), to remotely modify the answer verification algorithms, to consult the log files generated by the lock and to remotely detect other events linked to use of the lock. This communication with the central station 1 can also be performed through the device protected by the lock, for example by using a modem or router of this device. In one embodiment, the data exchanged by the lock and the central station 1 are signed and encrypted electronically, for example through a virtual private network (VPN) so as to preserve their confidentiality and authenticity even vis-à-vis the teller machine to be protected.

The lock 5 furthermore preferably includes an electronic clock 54 that allows it to determine the date and time autonomously and to calculate time intervals. Computing means (not represented), for example a micro-controller, a micro-processor with a memory, an industrial micro-computer, an asic-type circuit and/or a FPGA circuit etc. allow the dialogues with the user to be handled and the electro-mechanical device causing the locking or unlocking of the lock to be controlled. The computing means further preferably include a module, for example a software module, for generating and then displaying a question in response to an accepted personal identification code being entered, and a module, for example a software module, for verifying whether the answer to the question is correct and, if the answer is correct, for causing the lock to unlock.

The computing means are preferably protected against physical or software manipulations and can for example self-destruct, whilst keeping the lock closed, during fraudulent manipulations. The lock 5 can further include wireless connection elements with the mobile equipment 3, for example a Bluetooth-type interface, in order for example to detect and check the presence of this equipment in the vicinity; it is however possible to forgo these means if they cause added vulnerability.

The lock 5 is preferably electrically autonomous and powered by means of cells or batteries; it remains mechanically locked when the cells or batteries are empty. Recharging or replacing the cells or batteries can then be carried out without unlocking the lock. In a variant embodiment, the lock is powered electrically by the device into which it is mounted, for example a teller machine. In yet another embodiment, it is powered by means of a generator actuated by the user; the clock 54 uses in this case its own energy source to keep the time even if the rest of the system is no longer supplied electrically.

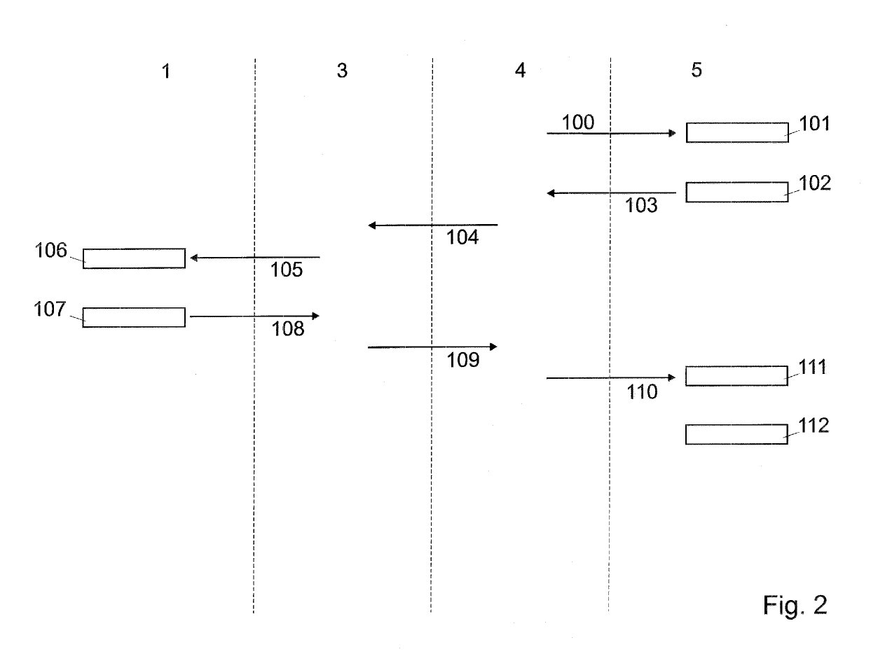

An embodiment of the inventive method will now be described with the aid of FIG. 2.

Initially, a user 4 wishing to unlock the lock 5 is physically in front of this lock and enters during the step 100 a personal code on the keypad 51, for example a numeric or alphanumeric code, for example a 6-digit code.

During the step 101, the computing means in the lock verify the entered personal code. In a first variant embodiment, the personal code is compared with a list of accepted codes (“white list”) stored in the lock. This variant however has the disadvantage of such a list having to be transmitted to the lock, for example through a telecommunication network or through the route personnel. Such a transmission is subjected to risks of interception or spying. In order to avoid this risk, in a second preferred embodiment, the lock merely verifies during step 101 whether the entered personal code is plausible, e.g. whether the code's format is admissible, whether a possible parity code is correct or whether the entered personal code does not belong to a list of rejected codes (“black list”) because they are non-existent or belong to refused users. The verification of the personal code entered by the user is, in this second embodiment, delegated to the central station, to which the code will subsequently have to be transmitted implicitly or explicitly.

If the lock detects during the step 101 that the entered personal code is invalid, it is rejected and an error message can be display on the display 50 to inform the user and invite him to enter a new code. In order to prevent “brute force” attacks, i.e. by testing in succession a large number of different codes, it is possible for example to introduce a deadline between each attempt and/or to limit the number of possible unfruitful attempts before blocking the lock for a longer period or until an unlocking operation has been initiated.

In a variant embodiment, the user is identified vis-à-vis the lock by proving possession of an object, for example a key, an electronic key, a chip card, etc. The presented object can itself be protected by a code, notably in the case of a chip card. This solution however has the disadvantage of requiring an organization for distributing and administering the objects to be presented. The user can also be identified by means of biometric data acquired by means of a biometric sensor, for example with the aid of his fingerprints, iris, retina, face, voice etc. These biometric data however have the disadvantage that they cannot be replaced with the ease of a personal code that can be transmitted at the last moment to the user; a recording of the user is furthermore required to acquire his reference biometric data.

Different identification methods can furthermore be combined. It is also possible to request an additional or different identification according to circumstances; for example, a biometric identification or identification with a key can be requested if identification by personal code has failed after a predetermined number of attempts or when the sum available in the protected volume exceeds a certain sum or whenever other circumstances call for increased security.

If the personal code is valid, the lock's computing means (or, subsequently, those of the central station) verify the access rights linked to the user identified by this code. The access rights can depend on the time; for example, it is possible to authorize the unlocking of the lock only during a limited temporal window corresponding to the time at which the user is expected. This temporal window can be encoded, with other information, in the central station's reply described further below.

Depending on the protected object, it is also possible to allow access to different parts of the protected volume to different users; it is for example conceivable to authorize a technical service rep to access only different organs of a teller machine, e.g. to refill paper, retrieve the log files or perform other maintenance operations, whilst access to the strongbox is restricted to other users identified with other codes.

The lock 5 can also verify whether a specific manipulation has been carried out when the personal code was entered by the user 4 in order to signal that he is under duress, for example because an assailant is forcing him to enter the code. The specific manipulation can involve for example entering a different personal code, pushing an additional key or organ, prolonged pressure on one key or other manipulations that can be identified without ambiguity by the lock 5 but is difficult to detect for an assailant observing the operation. The detection of a particular manipulation causes the lock to behave differently, as will be seen further below.

In case of valid identification, the lock 5 then displays during step 102 a question on the display 50. The displayed question can depend on the time, the date, the identified user, the lock, other parameters collected by the lock and/or a possible detection of manipulation signaling duress. Furthermore, the choice of the question can depend on a random factor. Each question is preferably displayed only once and is not re-used, or at least not for the same user. The displayed question can be generated by a mathematic function, for example a pseudo-random function, and/or selected in a table of predefined questions. In a preferred embodiment, the pseudo-random function depends at least partially on the value of a counter incremented at each opening of the strongbox and/or at each unlocking attempt; the counter can never be decremented and the maximum value that can be counted is sufficient to ensure that the counter does not re-loop. It would also be possible to use the time counted by the lock's clock to initialize the pseudo-random function; however, a clock should be capable of being set, and thus can be delayed, which could be used to “go back in time” in order to force the lock to generate again a question the answer to which is already known.

Fruitful identifications and unfruitful identification attempts are preferably recorded in a log file in the lock, with the date and time of the event. This file can be consulted by a technical service rep, for example by entering a particular code on the keypad 51, by plugging a computer on the connector on the front side of the lock and/or remotely from the central station 1 through a communication network.

The user 4 reads the question displayed during the step 103, then enters it during step 104 on the keypad of his mobile equipment 3. Since the question displayed on the display 50 is unpredictable and it is possible to distinguish the possible questions from illicit questions, one can thus make sure that the user 4 is indeed in the vicinity of the lock 5 to be opened.

During the step 105, the question entered by the user is transmitted by the mobile equipment 3 to the central station, for example in the form of a short message, for example SMS, e-mail, data packets, DTMF code or voice message spoken by the user.

A dedicated application, for example a Java applet (registered trademark) can be executed by the mobile equipment 3 to make it easier to enter the question and transmit it to the central station 1. In a variant embodiment, the question is simply entered by the user and transmitted to a telephone number or towards an e-mail address known to the user.

Access to the mobile equipment 3 or to the application mobile equipment can be protected by a password, a PIN code, or request from the user 4 other identification or authentication measures.

Beside the question entered by the user, the message transmitted to the central station 1 during the step 105 can include other information, including for example an identification of the used mobile equipment 3 (for example the MSISDN caller number), user identification data (including his personal code but also for example a password, a PIN code, biometric data, data extracted from a chip card in the mobile equipment, etc.), information on positions supplied by the geolocation module 30, information supplied by the LWP module 31, etc. The message can furthermore be signed electronically by a chip card in the mobile equipment 3 in order to prove its authenticity and integrity, and/or encrypted in order to ensure its confidentiality.

During the step 106, the central station 1 receives the message transmitted by the user and verifies it. The verification implies for example checking whether the transmitted question is a licit question, depending on the user that uses it, on the lock in front of which he finds himself, on the time, etc. If the user's personal code has been transmitted with the question or if it is implicitly contained in the question, the central station 1 can also ensure that this user is indeed authorized to access this lock at this moment, for example according to a route plan previously established for a route personnel moving between different locks. Other verifications can take into account the user's geographic location, data supplied by the LWP device, potential data supplied directly by the lock, information verifications signaling a manipulation to indicate duress, etc.

If the verifications performed during the step 106 allow to determine that the question is a legitimate question transmitted at the right time by an authorized user, the rights of this user are preferably determined. If the user has at least certain rights, an answer to this question is computed during the step 107, by means of an algorithm unknown to the users and executed by the computing means 11. The answer is preferably constituted by a digital or alphanumeric string that does not allow a user to determine immediately whether it contains implicit instructions for the lock.

In the opposite case where the received question is not valid, or if it has been transmitted by an unauthorized user, or when the user does not have the necessary access rights, or when other anomalies have been detected, no answer is computed. In one variant embodiment, an error message informing the user is then transmitted to the mobile equipment 3 and displayed by the latter, in order for example to allow the user to correct a typing error when entering the question. Alternatively, the central station can supply a modified answer causing a modified behavior of the lock. The reaction of the central station and the sent answer can also depend on the detected anomaly, on the number of unfruitful attempts or on other conditions.

If the central station detects, for example on the basis of the received question, that the user has effected a particular manipulation to indicate he is under duress, it preferably computes a modified answer relative to the normal answer in order to cause a particular behavior of the lock. Different modified answers can be chosen automatically or by human operators according to circumstances in order to trigger different reactions.

Other additional information can be encoded in the answer, for example to define the user's access rights to the lock, for example as a function of time.

The answer to the question is then transmitted to the mobile equipment during step 108, then displayed and read by the user during step 109. The answer can include for example a numerical or alphanumerical code and is entered by the user 4 on the keypad 51 of the lock 5 during step 110.

During step 111, the computing means in the lock 5 check whether the received answer is correct. In one embodiment, this verification entails a comparison with an answer computed by the lock itself by executing the same algorithm than that executed by the central station 1. In one embodiment, the checking of the received answer is performed without recalculating it independently, for example by verifying the received answer by means of a verification key allowing the possible answer or answers to the question to be distinguished from non valid answers, as a function of the question and/or other parameters. This variant embodiment has the advantage of not requiring copies of the algorithm in a plurality of locks disseminated over a territory; it is furthermore compatible with algorithms that supply several valid answers to a same question.

The computing means 5 further check during step 111 whether the received answer takes into account the detection of a manipulation by a user under duress or whether other parameters are encoded in this answer.

In one embodiment, the user indicates a state of duress to the lock 5 when entering the answer on the keypad during step 110, for example by entering an additional digit etc. This solution is however less secure since a usurper could himself enter the answer without effecting any additional manipulation. Furthermore, the central station is not informed of any manipulation.

In an additional embodiment, a state of duress is directly detected by the lock 5 from additional sensors or data, data transmitted by the teller machine to which the lock is linked, or data transmitted directly by the central station 1.

If the lock determines during step 111 that the entered answer is correct and that it does not correspond to a state of duress, the lock is unlocked during step 112, until the next manual locking or during a limited period. The user can thus access the protected volume or part of this volume. This event is recorded in the log file, with indication of time and length of the unlocking. Furthermore, the counter used for initializing the pseudo-random function is incremented irreversibly.

If the lock determines during step 111 that the answer entered is incorrect, the lock remains locked and an error message can be displayed on the display 50. After a predetermined number of unfruitful attempts, an alarm can be triggered locally or sent to the central station 1 or towards another predetermined address. In one embodiment, the banknotes in the teller machine are automatically destroyed or marked with indelible ink.

If the lock determines during step 111 that the entered answer is correct but that it corresponds to a state of duress, it performs one of the following actions according to the answer:
locking the lock or maintaining the lock locked, possibly even if a correct answer is entered subsequently during a limited period,
normal unlocking of the lock,
delayed unlocking of the lock after a short period but longer than the usual period,
delayed unlocking of the lock after a long period, for example greater than three minutes,
displaying of a particular message on the display 50 of the lock, for example to indicate to the assailant that he has been discovered,
triggering an alarm, for example a sound alarm,
destroying the contents of the protected volume by the lock, for example by marking the banknotes by means of indelible ink,
etc.

The last two options must however be used with restraint in order to avoid the risk of the legitimate user being taken hostage or becoming the victim of retaliation.

These different measures can further be combined.

After entering a correct answer or an answer indicating a manipulation, a receipt code is preferably displayed during an additional step (not represented) on the display 50. The user then enters this receipt code on his mobile equipment and transmits it to the central station 1, in the same manner as for the question previously, in order to indicate to the central station that his mission has been completed. The required receipt code is preferably unique and unforeseeable in advance, so as to ensure that the user has indeed read it following manipulation and that he has not deduced it otherwise. The central station is however capable of verifying whether the transmitted receipt code is licit.

Again, the receipt code generated by the lock or entered again by the user can contain indications signaling to the central station particular events, for example to indicate whether the lock has been opened, a new state of duress or any other event. The transmitted receipt code can furthermore, as for the question previously, be signed, encrypted and accompanied by data such as the date, time, user identification, mobile equipment, geographical position etc. The central station can thus verify these data or detect the lack of sending of a receipt message after a predetermined period, to decide an appropriate measure including the triggering of an alarm, the triggering of an intervention and/or the locking of other locks in the vicinity or on the user's foreseen route even in case of a correct operation.

The generated receipt code is preferably, in the same manner as the question or response, dependent on the user en route, on the current lock and/or on other parameters such as the date, time, detection of possible manipulations.

In the above method, an authorization to unlock a specific lock by a specific user can be modified by the central station 1 in one of the following ways:
By communicating a new personal code to the user, for example by means of a telephone call, SMS, e-mail or other message sent to the mobile equipment 3 or transmitted orally to the user.
By modifying the personal codes accepted by the locks 5, for example by sending new lists of accepted codes (white list; only in the embodiment where these lists are stored in the lock), new lists of refused codes (black list), new lists of suspect codes requiring additional verification (grey list) or by modifying the access rights linked to these codes. The lists of codes and the access rights can be transmitted by a telecommunication channel through a telecommunication interface in the lock and/or by means of a telecommunication interface linked to the device protected by the lock or entered directly through a physical data carrier by a technical rep in charge of maintenance.
By modifying the personal codes accepted by the central station according to the white, grey or black lists or other parameters such as the user's planned route.
By modifying the answer given to a question transmitted by a user or by refusing to answer these questions.
By sending a command directly to the lock, for example a command to maintain locking during a lapse of time.

Furthermore, regardless of the central station's behavior, the lock 5 can itself authorize or refuse unlocking according to parameters acquired directly or through the protected device, for example with the aid of sensors, cameras or microphones linked to the lock or to the device, obtained by analyzing the user's manipulations on the keypad 5 or according to an internal history log of this user's manipulations and/or of the lock 5.

It is however possible, within the frame of the invention, to provide only some of the unlocking authorization possibilities mentioned here above.

The lock described here above can be used for making secure volumes other than teller machines, for example weapon chests used in police stations or by the army, safes or other volumes that can be locked or unlocked by a local user only if authorized by a remote central station.

Furthermore, the inventive lock can be programmed at any time, for example from the central station and/or by means of a particular code entered by a user in the vicinity, in order to function in a mode other than the interactive mode described here above. For example, it would be possible to reprogram this lock to authorize it to be unlocked by certain users or even by all users without establishing a connection with the central station.

1. Method for controlling the locking of an electronic lock, including the following steps:
a user is identified vis-à-vis the electronic lock,
the electronic lock displays a question,
the user transmits the question to a central station,
the central station computes the answer to the question and transmits this answer to the user,
the user enters the answer in the lock,
the lock verifies whether the response is correct and decides according to this answer whether to unlock the door.

2. The method of claim 1, wherein at the end of the manipulation, a receipt code is displayed by said lock and transmitted by said user to the central station with the aid of a mobile equipment.

3. The method of claim 1, wherein a different question is displayed at each access to the lock.

4. The method of claim 1, wherein said central station verifies if said question is valid.

5. The method of claim 1, wherein the displayed questions depend on said users.

6. The method of claim 1, wherein said answer to said question is computed by means of an algorithm in said central station,
and wherein said lock verifies by means of the algorithm or algorithms executed in the lock whether said answer is correct.

7. The method of claim 1, wherein said user transmits said response to said central station by means of a communication established through a cellular network independent from said lock.

8. The method of claim 7, wherein said user transmits said answer to said central station by means of a mobile equipment capable of connecting into a cellular network,
said mobile equipment determining the position of said user by means of a geolocation device,
said position being transmitted to said central station,
said central station checking said position before transmitting said answer to said question.

9. The method of claim 7, said mobile equipment using a lone worker protection equipment in order to determine whether said user is alive and/or awake.

10. The method of claim 7, said mobile equipment authenticating said user by means of a chip card, a personal code and/or biometric data.

11. The method of claim 10, the identity of said user determined in said mobile equipment being transmitted to said central station for verification.

12. The method of claim 1, wherein said user is identified vis-à-vis the electronic lock by means of a personal code entered on a keypad of the lock.

13. The method of claim 12, wherein a new personal code is transmitted by said central station to said user.

14. The method of claim 1, including a preliminary step of defining the access rights of the users identifying to said lock.

15. The method of claim 1, wherein said user performs a particular manipulation when entering said question into said lock when wishing to indicate he is under duress,
said central station then reacting by generating a modified answer to said question, said modified answer being different from the answer generated when said manipulation is not performed,
said lock modifying said locking conditions when said user enters said modified answer.

16. The method of claim 15, wherein said central station selects a modified answer from among several when one such manipulation has been detected, the entering of at least certain of the different modified answers causing at least certain of the following behaviors:
keeping the lock locked;
temporizing the unlocking of the lock;
displaying a message on the display of said lock;
triggering an alarm;
destroying or marking the contents of the device protected by said lock.

17. The method of claim 2, wherein a different receipt code is displayed at the end of each manipulation.

18. The method of claim 2, wherein said receipt code depends on the current user, the opening of the lock, the current lock, the date, the time and/or the detection of possible manipulations.

19. Electronic lock, including:
data entering means for entering a personal identification code,
a module for generating and then displaying a question in reply to the entering of a personal identification code,
a module for verifying whether an answer to said question entered on said keypad is correct and for causing said lock to unlock in case of a correct answer.

20. The lock of claim 19, including means for generating and displaying a receipt code after an unlocking attempt.

21. The lock of claim 19, including means for verifying the plausibility of said personal code, said means being without any list of authorized users.

22. The lock of claim 19, including means for detecting manipulations of the user, said generated question being modified when such a manipulation has been detected.

23. The lock of claim 19, including means for temporizing the unlocking of the lock according to the entered answer.

24. The lock of claim 19, including a log file for inventorying the events caused by said users.

25. The lock of claim 19, including a clock powered permanently to determine the time and date.

26. The lock of claim 19, including a counter that can be incremented irreversibly to initialize a pseudo-random function used for generating said question.

27. The lock of claim 19, including an interface for exchanging data with a device protected by said lock.

28. The lock of claim 19, including an interface for exchanging data with a remote central station.
